(19) United States
(12) Patent Application Publication
(10) Pub. No.: US 2003/0200313 A1
(43) Pub. Date: Oct. 23, 2003

(54) Digital rights management system for clients with low level security

(75) Inventors: Petr Peterka, San Diego, CA (US); Jiang Zhang, San Diego, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: General Instrument Corporation, Horsham, PA

(21) Appl. No.: 10/125,294

(22) Filed: Apr. 17, 2002

(51) Int. Cl. G06F 15/16

(52) U.S. Cl. 709/225; 709/229

(57) ABSTRACT

A system for determining whether a client is authorized to access content in a communication network. The system includes a computer software product containing programming instructions for defining generic rules for accessing the content, and for identifying client selections related to the content. The computer software product further includes programming instructions for providing client entitlement data. The client entitlement data is compared to the generic rules and the client selections to determine whether the client is authorized to access the content. The computer software product further includes programming instructions for comparing the client entitlement data with the generic rules and the client selections to determine whether the client is authorized to access the content.

### COPYRIGHT NOTICE

A portion of the disclosure recited in this specification contains material which is subject to copyright protection. Specifically, code and other text that is executable, or functionally interpretable, by a digital processor is included. The copyright owner has no objection to the facsimile reproduction of the specification as filed in the Patent and Trademark Office. Otherwise all copyright rights are reserved.

### BACKGROUND OF THE INVENTION

The present invention relates generally to the field of communication systems and more specifically to a system for managing digital rights.

Electronic communication networks such as the Internet have created an increased demand for digital content. Along with this demand, is the need to manage digital rights associated with millions of users. Digital rights management is used to provide content only to authorized entities in a communication network.

As an example, in cable access systems, digital rights management ensures that MPEG streams are received only by authorized set-top boxes. In such cable access systems, digital rights are typically enforced at the set-top box since such hardware devices are relatively more secure vis a vis software based devices. Rights management messages are sent to the set-top box where they are evaluated. One such message is an entitlement management message (EMM) for conveying access privileges belonging to a particular subscriber. Another type of message known as an entitlement control message (ECM) specifies access rules for the content stream and conveys cryptographic information for computing cryptographic keys. After both messages are received, the client evaluates the messages to determine if the set-top box is authorized to receive the MPEG stream. If authorized, the set-top box is allowed to access the MPEG stream.

Disadvantageously, this cable digital rights management system is unsuitable for computing networks because many such networks have software-based clients with a low trust level. An IP network is an example of such a network. Applying the EMM/ECM approach to an IP network, for example, may likely result in loss of content due to content piracy.

Moreover, there is no flexibility in the EMM/ECM approach. For example, digital rights management language for expressing EMM/ECM messages cannot be extended to suit different network architectural models. This language is specifically designed to express content access rules that are enforced at the end user device.

Therefore, a need exists to resolve one or more of the aforementioned problems and the present invention meets this need.

### BRIEF SUMMARY OF THE INVENTION

One aspect of this invention is a digital rights management system for determining whether clients are authorized to access content within a communication network. Preferably, the client is software based. However, the client may be hardware based, or may be a combination of software and hardware.

The client, wishing to access content, initially registers at a content provider. Subsequently, the client may request content at any time having provided the requisite registration information. When content is requested, digital rights management objects are delivered to a location remote from the client. At this location, the rights management objects are evaluated to determine whether the client is authorized to access content. Advantageously, by using remote evaluation, the present invention shifts evaluation tasks away from clients, particularly software-based clients that are vulnerable to cryptographic attacks. After remote evaluation is completed, and if the client is authorized, the content is securely delivered from the content provider (or a caching server) to the client. Various aspects of the present invention are disclosed.

According to a first aspect, the system comprises a computer software product containing programming instructions that define generic rules for providing access to the content. Generic rules are content specific and are independent of the client. An example is a blackout rule where access to content is restricted to certain geographical locations. Another example of a generic rule is a list of subscription services to which the content belongs. Other examples of rules are discussed in the specification, below. Note that generic rules are typically defined in a session rights object. Upon receiving a content request, the content provider forwards this session rights object to the client.

The computer software product includes programming instructions for identifying client selections such as payment options selected to pay for the content. A payment option may be pay-per-view, for example. Or, it may be pay-by-time, subscription, etc. By separating client selections and the generic rules, the present invention permits enforcement to occur at a location remote from the client. Remote evaluation is particularly advantageous to software based clients, although it is applicable to hardware based clients as well. Note that client selection may be included in the session rights object along with the rules, for delivery to the remote location. Alternatively, the rules and client selection may be delivered separately to the remote location for evaluation.

The computer software product further includes programming instructions for providing authorization data for defining the client's entitlements. An entitlement is the client's right to content. It may include subscribed services, geographical location, client payment method, and other relevant data that are specific to the client.

The authorization data, rules and client selections (e.g., payment options) are delivered to a location remote from the client. This location may be a caching server, for example, that is closest to the client. In fact, the information may be delivered to a third party system for evaluation. Upon evaluation, and if the authorization data matches the client selection information/content access rules, the client is allowed to access the content.

### BRIEF DESCRIPTION OF THE DRAWINGS

FIG. 1 is a block diagram of a communication network in which the present invention is employed.

FIG. 2 is a screen shot illustrating a content rights element that defines generic rules for content access in accordance with one embodiment of the present invention.

FIG. 3 is a screen shot illustrating a client selection element for identifying selections made by a client in accordance with one embodiment of the present invention.

FIG. 4 is a screen shot illustrating an authorization data element for defining the client's entitlement in accordance with one embodiment of the present invention.

### DETAILED DESCRIPTION OF THE INVENTION

A digital rights management system for determining whether a client is authorized to access content in a communication network. The content is typically provided by a content provider to a caching server closest to the client. The client registers and requests the content from the content provider. Management objects are delivered to a remote location for evaluation. If the client is authorized, content is delivered from a caching server (or content provider) to the client.

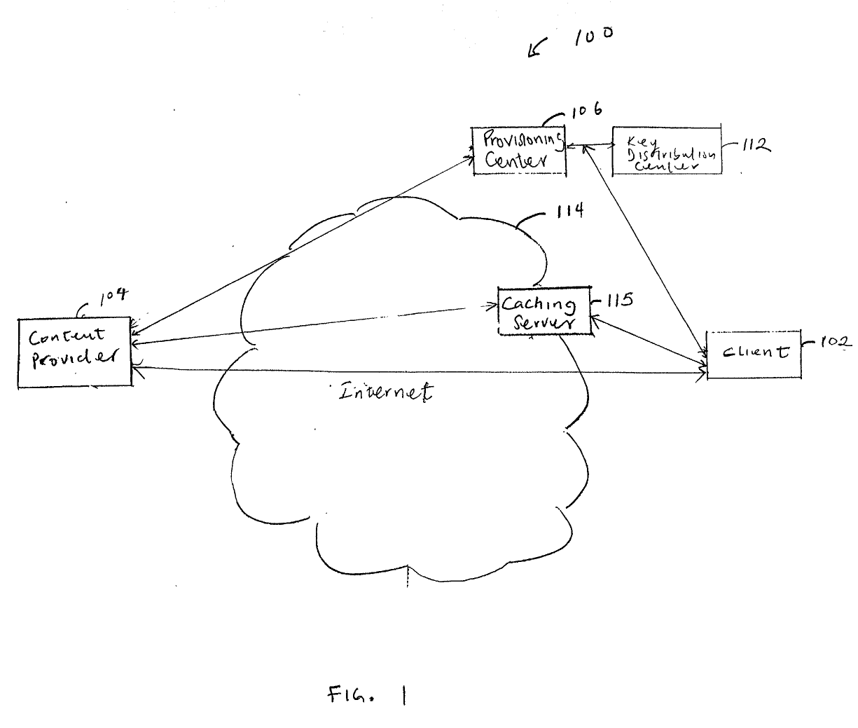

FIG. 1 is a block diagram of a communication network 100 in which the present invention is employed. Specifically, it is determined whether a client 102 is authorized to access content generated by content provider 104.

Among other components, network 100 includes content provider 104 for generating the content and the Internet 114 through which the content is streamed. Further, network 100 includes a KDC (key distribution center) 112 serving as a trusted third party arbitrator, a provisioning center 106, and at least one caching server 115 for streaming content to client 102.

In use, client 102, desiring content from content provider 104, begins by registering at provisioning center 106 and KDC 112. This registration process securely establishes the identity of client 102 such that the client's identity cannot be replicated. After registration, certain required information is furnished by client 102 to content provider 104. This information includes a list of one or more caching servers closest to client 102; in this case, caching server 115. When the client is authorized, the content is streamed from this caching server to client 102. Other information optionally furnished to content provider 104 includes a list of the client's subscribed services, the client's ability to pay for content, etc.

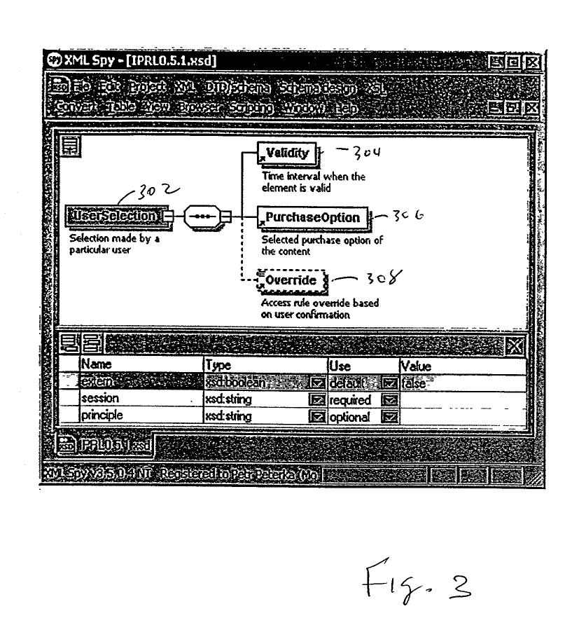

Thereafter, various purchase options are presented to client 102 by content provider 104. These purchase options indicate whether content is free, subscription only, pay-per-view, and so forth. Thereafter, a desired purchase option is selected by the client. After selection, a session rights object is provided to client 102 by content provider 104. The session rights object generally contains client selections, including the purchase options for paying for the content. Another attribute of the client selection may be a time period for which the client selection element is valid. Note that the client selection may contain other attributes as well. The client selection element is further described with reference to FIG. 3, below.

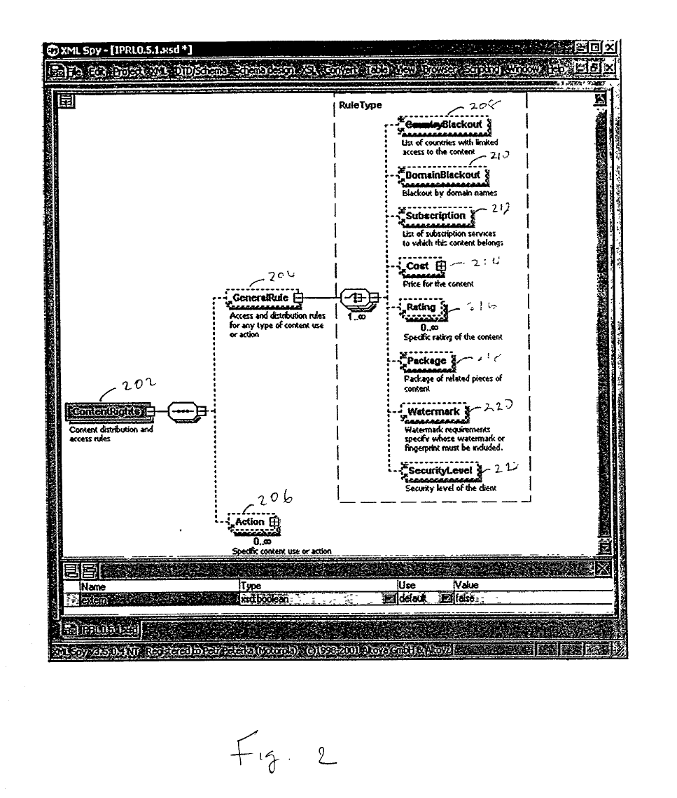

In addition to client selections, the session rights object may contain content rights information, namely, generic rules used for providing access to content. An example of such a content access rule may state that content cannot be accessed outside designated geographical locations. This content right element is further described with reference to FIG. 2.

After the session rights object is received, the client is redirected to caching server 115. Note that client 102 may have previously obtained a caching server ticket from the KDC. A ticket is an authentication token that includes authorization data indicating subscribed services, client payment method, etc. It may include the client's identity, the server's name, a session key, etc.

Thereafter, the authorization data (from the ticket) and the session rights object are presented by client 102 to caching server 115. In this manner, according to one aspect of the present invention, the authorization data and the session rights object are evaluated remotely from client 102. Remote evaluation is particularly advantageous where client 102 is software-based and is vulnerable to cryptographic attacks. The caching server compares the client selection and/or content access rules in the session rights object with authorization data from the ticket. If this information matches, content is streamed to the client. In this manner, the present invention provides a system for securely determining whether a client is authorized to access content.

FIG. 2 is a screen shot illustrating the structure of the content rights element in accordance with one embodiment of the present invention. The content rights element defines generic rules for allowing access to content, and rules for billing and streaming as well. Rules for billing and streaming include cost and watermark rules, for example.

In one aspect, the content rights element is defined by using IPRL (Internet protocol rights management language) which itself is defined using XML (eXtensible mark-up language). IPRL provides a set of elements that may be grouped into three higher-level elements namely the content rights element, the client selection element and the authorization data element. All of these elements are employed for securely determining whether a client should be granted access to content.

As shown, the content rights element 202 comprises an action element 206 and a general rules element 204. The general rules element 204 specifies rules associated with the use of the content regardless what action is performed. The action element 206 specifies a set of rules associated with a particular action or type of content use.

Although not illustrated, a content identification element is also provided. Content may be identified by different means, e.g., URI (universal resource identifier). Therefore, this element includes the type of identification and the identification itself. If type is not provided, URL (universal resource locator) may be used as the default identification type. It may optionally include a string containing content name and/or description.

Action or Use

As noted, the action element 206 is provided by the present invention. Content may be used in different ways, such as a video being viewed, music listened to, a book being printed, etc. Uses such as these are mostly controlled by client 102 and are more applicable to trusted clients. The type of use that caching server 115 delivering the content may control to some extent is streaming vs. download. Content provider 104 may limit content download to fully trusted clients while streaming may be allowed to clients with a lower level of security. The criterion would be the security level indicated in the authorization data.

General Rule/Access Rules or Access Limitations

Access rules specify the constraints associated with the different uses of content. Rules may be specified at the top level (at the content identification level) if they apply to all uses of the content. If certain rules are applicable to a specific use of the content, they may be listed within the action definition.

Blackouts

The blackout element 208, in general, may restrict access to content to specific geographical or other types of regions. This access restriction may be inclusive (spot beam) or exclusive. Content distribution may be restricted to certain geographical areas. Such areas may be defined by country codes, ZIP or postal codes, latitude and longitude, XYZ coordinates, etc.

Another type of blackout may use virtual grouping where end-clients may be allocated to one or more of these virtual groups and content distribution may be limited to that group. Blackouts may also be defined based on IP address ranges. Content distribution may also be controlled by the network service provider (ISP) or broadband operator (BBO). Thus blackout may be defined in terms of the ISP or BBO the end client belongs to. One of ordinary skill will realize that the aforementioned are simply examples of blackouts, and other type blackouts within the spirit and scope of the present invention may be employed.

Domain

DomainBlackout element 210 is provided to target content based on a domain name. For instance, a web-based training may be offered only to students of a certain university with an account at the university (e.g., ucsd.edu).

Subscription

As shown by subscription element 212, some content may be offered on a subscription basis. Client 102 subscribes to a service from content provider 104 for a flat fee and is thereafter entitled to receive any content on that service. A subscription ID may be assigned to client 102 in order to receive such service. With the number of potential services offered on the Internet 114, a subscription ID may be a combination of a content provider ID, which is unique across the service provider, and a service ID, which is unique only within each content provider. The subscription element includes the content provider ID (unless specified as part of the content ID), the service ID and an optional title or description.

Cost

As illustrated by cost element 214, content may be offered under multiple purchase options, such as PPV (pay-per-view), PBT (pay-by-time), subscription, etc. Different purchase options may include additional attributes, such as the time increment period for PBT, maximum number of viewings for PPV, etc. Each purchase option may also include an associated price of the content. This price is guaranteed until this object expires, even if the price of the content changes before the content is requested by the client. Price may be tagged with a currency (e.g., ISO 4217). US dollars may be used as the default currency.

Content Rating

The rating element 216 illustrates that each piece of content may be assigned a certain rating level. Clients such as client 102 may set up in their personal preferences a rating ceiling (maximum rating level allowed), which may be used to block access to content. Generally, there are two locations where rating limits may be enforced: at client 102 or at caching server 115. Note that these are exemplary options and are not necessarily limiting. For example, a third possible solution is that the rating ceiling is enforced by caching server 115 but override is allowed at the site which generates the client selection data. This solution assumes that caching server 115 accesses the client database and verifies the rating ceiling override password. Content rating may be multidimensional similar to today's cable TV, broadcast TV or movie ratings. Both the dimension as well as the level in each dimension may be described by this element.

Packages

As illustrated by package element 218, similar to the subscription element described above, content may be grouped into packages of related content, such as episodes of one show, NHL games, etc. Packages may be managed similarly to subscriptions. A content provider ID and a package ID identify each package.

Watermark

A watermark element 220 may be provided. Content provider 104 may require that selected content be identified with a watermark carrying information about client 102 the content is being distributed to. If this rule is enabled, caching server 115 extracts client-specific information from the ticket and embeds it into the content before streaming it. This rule may specify whose information is to be embedded in the content: (1) content owner, (2) content distributor, (3) network provider or (4) the end client.

Security Level

As shown, a SecurityLevel element 222 is provided. Some content may be restricted to client devices with a predetermined level of security, e.g., hardware-based security chip, smartcard, etc. For example, a new movie may be streamed to clients with a high level of security in the hardware chip. Another use for this rule is to specify the strength of an encryption algorithm used for the requested content. For example, the rule may specify a fixed (known) key algorithm, a specific type of algorithm, etc. In fact, a no encryption rule may be specified.

Network Provider

Although not illustrated in FIG. 2, a network element rule may be provided. Content may be restricted by the broadband operator providing the “last mile” service. This information may be used in conjunction with the blackout mechanism. A network provider may be associated with each action, if desired, in the form of an element or an attribute, if different rules apply depending on the end client's network provider. This mechanism allows the network provider with a better network e.g., with a be a Quality of Service, to increase its prices.

Promotions

A further element that may be provided is a promotion element. Content provider 104 may support different promotional mechanisms such as coupons, discounts for long-time customers, etc. This rule identifies whether promotions are allowed and, if so, what types of promotions. This rule may be an attribute of the rules describing the cost of purchasing the content. Content provider 104 may offer discounts for new customers (the length of membership is in the authorization data), such as free movies the first month of service, 50% discount for the first three months of service, etc. Loyal customers could get discounts as well, e.g., “the longer you stay with us, the less you pay,” or “get a free movie every six months.”

Time of Day Constraints

A TimeOfDay element may also be implemented. In order to smooth out network traffic and minimize congestion, content may be offered at a discount price at off-peak hours. Client 102 either selects the limitation which is encoded in the client selection or in the content rights. Caching server 115 records the time of actual use and reports that to the billing system for proper billing.

Other rule elements may specify how the actual billing for content is executed: (1) by content provider, (2) by service provider, (3) by the network operator, etc. This rule is not used when clients request the content but after the purchase has been reported to the billing system.

FIG. 3 is a screen shot illustrating the client selection element for identifying selections made by client 102 in accordance with one embodiment of the present invention. Note that the client selection element may identify other attributes as well.

Client Selection

The client selection element 302 represents the choice made by client 102 while browsing content, and access rules description, e.g., by browsing the content provider web page. This data structure may also limit the use of the client selection object to a defined time period. The client selection element 302 represents a right to consume the content, assuming all access rules are satisfied. The content must be consumed within a certain time period, i.e., time limit of a contract. For example, this price is good for the next 2 hours. The structure of client selection element 302 consists of the following top-level elements:

Validity Period

A validity period element 304 is included in the client selection element. Because the client selection object may be analogized to a contract with guaranteed price for the specific content, this object is time bound. It may include an expiration time after which this information cannot be used to obtain the actual content. In addition, it may indicate a time period in the future for which the contract is valid. Time values are generally in universal coordinated time(UTC) format.

Purchase Option and Price

A purchase option element 304 is included in the client selection element. If the content is offered under multiple purchase options, such as PPV, PBT, subscription, etc., client 102 may select one of them. Note that an option is assigned automatically if client 102 has a subscription to this service. The client is automatically assigned the subscription option since the content has already been paid for by the monthly fee.

This element may optionally include discounts, coupons and other promotions. For instance, the page, where the end client selects the content and the corresponding purchase options, may include a request to provide her/his e-mail address for a 10% discount. This information may be included in this element so that the billing system can apply the discount.

Access Rules Override

An access rule override element 308 is provided. This access rule override allows certain rules for a given end client to be overridden. For instance, if the client can authenticate himself with a password, the rating ceiling may be temporarily disabled for the selected piece of content.

One of ordinary skill in the art will realize that other rule elements that are not shown may be included in client selection element 302. For example, a quality/resource restrictions element, a secure session identification and a content identification may be included. The quality/resource restrictions element relates to content delivered in different formats and with different levels of quality (HD vs. SD, compression ratio, bandwidth, etc). Quality could be linked to the security level of the, client's device or different cost could be attributed to HD or SD format or to delivery with QoS.

The secure session identification element is a unique identifier that ties all components of a streaming session (or a download session) together, such as encryption keys, access rules, etc. The content identification element may be used when the client selection element 302 is not delivered together with content rights element 202.

In one aspect of the present invention, the client selection and the content rights are included in a session rights object. This object is received by client 102 from content provider 104. Thereafter, the session rights object is forwarded to caching server 115. One of ordinary skill in the art, however, will realize that client selections and content rights need not be combined in a session rights object. These components may be separately delivered to the caching server. The relationship between content rights and client selection is one-to-many. This relationship allows the content rights file to be created and delivered only once, while the client selection is generated for each client. Thus, the content file may be created once and delivered to caching server 115 via a route separate from the client selections. The rules and selection elements indicate whether they are delivered together or separately.

In addition, based on the client selection some rules are not applicable (e.g., if client obtains content using a subscription, rules about pay-per-view are irrelevant). If the content rights and client selection come in the same file, irrelevant rules may be omitted from the content rights element.

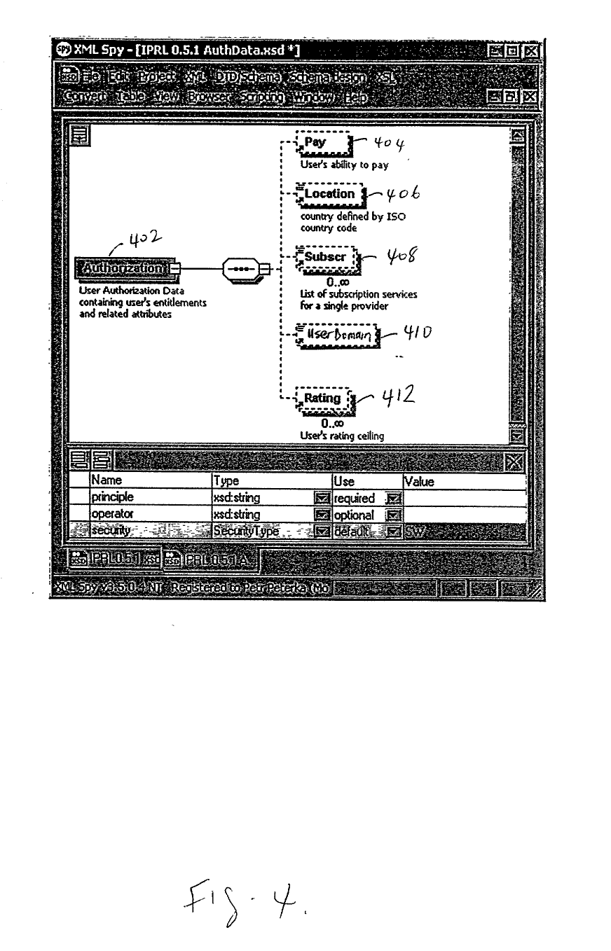

FIG. 4 is a screen shot illustrating a structure of the authorization data element 402 in accordance with one embodiment of the present invention. This element defines the client's entitlement or rights to access particular content.

The client's entitlements include subscribed services, geographical location, client payment method, and other relevant client data. Note that this data is client specific. The authorization data is stored in a client authorization database maintained by provisioning center 106 or an associated entitlement server (not shown). The structure of the authorization data element 402 consists of the following top-level elements:

Ability to Pay

The pay element 404 characterizes the ability of client 102 to pay for content. This ability may be characterized as none (i.e., for free content), subscription only (prepaid services), PPV, existing network provider account (e.g., existing cable bill), etc. All of this information is typically obtained when the client registers for content.

Client Location

The location element 406 describes the geographical location of the client. The client location is compared with the geographical blackouts to determine whether client 102 is authorized to receive content. This element may take on different levels of granularity, starting with a country code, ZIP or postal code, all the way down to latitude/longitude or XYZ coordinates.

Subscription List

The subscription element 408 contains a list of all subscribed services consisting of the service provider ID and the service ID. If client 102 purchases multiple services from the same provider, the provider ID does not have to be repeated with every service. In this case the provider ID is an attribute of an element containing a list of service IDs belonging to that provider.

User Domain

A user domain element 410 is provided. Each user may be identified by his/her assigned domain name, such as all students at University of San Diego would have the ucsd.edu domain name.

Rating

A rating element 412 is provided to identify the client's rating ceiling for each content.

Other Attributes

Although not illustrated, other rule elements may be provided. The following are other such exemplary rule elements. 1. Length of patronage: This attribute specifies how long client 102 has been an active member of the service. This information may be used for certain types of discounts. 2. Enforce rating at server: Content rating may be enforced locally on client 102 or remotely on caching server 115. This attribute specifies whether the rating is enforced locally or remotely. 3. Network Provider: Each client may be assigned a primary network provider or broadband operator. Such an operator may impose additional rules on the content. 4. Package List: This is a list of all prepaid packages consisting of the service provider ID and the package ID. 5. Virtual Grouping: Clients may be grouped into virtual groups, such as movie-of-the-month club, senior citizens, etc. 6. Personal Settings: Personal settings may include limits such as a rating ceiling for each rating dimension. Additional settings may be defined in the future. 7. Watermark Information: This is information embedded in the content by the caching server 115 if content provider 104 owner requires it. 8. Device Security Level: When clients register as new customers (or update their profile), their device security level is determined and stored in the authorization data. 9. Client Identification: This element uniquely identifies client. It is a number assigned to the client's account and device when it is initially provisioned.

Although the structural elements of the elements have been described according to IPRL and XML, one of ordinary skill in the art will realize that software instruction based on other languages within the spirit and scope of this invention may be employed. In this fashion, the present invention provides a digital rights management system for determining whether a client is authorized to access content in a communication network.

While the above is a complete description of exemplary specific embodiments of the invention, additional embodiments are also possible. Thus, the above description should not be taken as limiting the scope of the invention, which is defined by the appended claims along with their full scope of equivalents.

[image]

[image]

[image]

[image]

[image]

[image]

[image]

[image]

[image]

What is claimed is:

1. A computer software product for managing digital rights in a communication network, the computer software product comprising:
one or more programming instructions for defining generic rules for accessing content;
one or more programming instructions for identifying selections made by a client to access the content;
one or more programming instructions for providing client entitlement data; and
one or more programming instructions for comparing the client entitlement data to the generic rules and the selections to determine whether the client is authorized to access the content.

2. The computer software product of claim 1 wherein the one or more programming instructions for comparing is processed at a site remotely located from the client.

3. The computer software product of claim 1 wherein said generic rules comprise
purchase options and a cost for the content, said purchase options including one or more of pay per view, pay by time, subscription and free.

4. The computer software product of claim 1 wherein said selections made by the client include one or more purchase options.

5. The computer software product of claim 1 wherein said client entitlement data includes one or more of the client identification, the client's ability to pay for content and the client's geographical location.

6. The computer software product of claim 1 wherein said generic rules comprise blackout rules for restricting access to content according to one or more of the following: country, geographical region, interest group and zip code.

7. The computer software product of claim 1 wherein the generic rules further comprise
a list of subscription services to which the content belongs including a package of sporting activities, ongoing series, or movie channels.

8. The computer software product of claim 1 wherein the generic rules further comprise a rating for the content.

9. The computer software product of claim 1 wherein the generic rules further comprise
a package having the content and other related content.

10. The computer software product of claim 1 wherein the generic rules further comprise
a level of security attributable to the client such that content received by the client is securely protected.

11. The computer software product of claim 1 wherein the generic rules further comprise
information indicating that a watermark is to be added to the content, the information identifying any one or more of the following: a client, a content owner, a content distributor, or a network provider.

12. The computer software product of claim 1 wherein the generic rules further comprise
a restriction requirement specifying a time or day during which content can be obtained.

13. The computer software product of claim 1 wherein the generic rules further comprise
a rule for identifying promotions that are allowed, said promotions for encouraging purchase of content.

14. The computer software product of claim 1 wherein the generic rules further comprise
a rule for restricting access to content to a domain.

15. The computer software product of claim 1 wherein the generic rules further comprise
a rule for restricting content distribution to a network provider.

16. The computer software product of claim 1 wherein the generic rules further comprise an optional price for the content.

17. The computer software product of claim 1 wherein the selections made by the client further comprise
a session identifier for associating all components of a session, the session for delivering content to the client.

18. The computer software product of claim 1 wherein the selections made by the client further comprise
an identifier for identifying the content.

19. The computer software product of claim 1 wherein the selections made by the client further comprise
a validity period for identifying a time period, and when the time period expires, the client no longer has access to the content.

20. The computer software product of claim 1 wherein the selections made by the client further comprise
a purchase option for the content selected by the client.

21. The computer software product of claim 1 wherein the selections made by the client further comprise
a rule for overriding one or more rules related to the content.

22. The computer software product of claim 1 wherein the selections made by the client further comprise
a rule for restricting content to a particular quality.

23. The computer software product of claim 1 wherein the client entitlement data further comprises
an identifier for identifying the client; and
a client domain for identifying the client's domain name.

24. The computer software product of claim 1 wherein the client entitlement data further comprises
a subscription list having a provider identifier and a service identifier for the content; and
a package listing all content paid for by the client.

25. The computer software product of claim 1 wherein the client entitlement data further comprises
a grouping for classifying clients into virtual groups.

26. The computer software product of claim 1 wherein the client entitlement data further comprises
a personal setting including maximum content rating level; and
a watermark for identifying the client or content provider.

27. The computer software product of claim 1 wherein the client entitlement data further comprises
a security level for the client.

28. The computer software product of claim 1 wherein the client entitlement data further comprises
a flag for determining a location at which content rating is enforced.

29. The computer software product of claim 1 wherein the generic rules further comprise
a rule for limiting content delivery to clients with a specified security level.

30. A computer software product comprising:
a first object comprising a first portion and a second portion,
the first portion includes purchase options for purchasing content and further including blackout restrictions, the second portion includes client selections that include one or more of the purchase options;
a second object comprising the client's geographical location, and further comprising the client's ability to pay for the content; and
the client's location being compared to geographical locations from which the content is accessible, and the client's ability to pay for content being compared to the purchase options in order to determine whether the client is authorized to access the content.

31. The computer software product of claim 29 wherein said purchase options is any one or more of pay per view, pay by time, subscription or free.
